(19) United States
(12) Patent Application Publication
(10) Pub. No.: US 2006/0237476 A1
(43) Pub. Date: Oct. 26, 2006

(54) Apparatus for orienting and conveying small objects

(75) Inventors: Detlev Gertitschke, Laupheim (DE); Harald Litke, Achstetten (DE)

Correspondence Address: THE FIRM OF KARL F ROSS, 5676 RIVERDALE AVENUE, PO BOX 900, RIVERDALE (BRONX), NY, 10471-0900, US

(73) Assignee: UHLMANN Pac-Systeme GmbH & Co. KG

(21) Appl. No.: 11/407,407

(22) Filed: Apr. 19, 2006

(30) Foreign Application Priority Data
Apr. 21, 2005 (DE) 102005018651.3

(51) Int. Cl. B65B 5/10; B65B 35/06; B65G 47/14; B23Q 7/12

(52) U.S. Cl. 221/156; 221/208

(57) ABSTRACT

An apparatus for orienting and conveying small objects has a vessel having a horizontal floor having an upper face and formed with a throughgoing aperture, a conveyor passage extending away from the aperture, and a pair of bodies on the floor flanking the aperture and having confronting and upwardly diverging faces forming a funnel open downward at the aperture. Drives are provided for shifting the bodies toward and away from each other.

### FIELD OF THE INVENTION

The present invention relates to an apparatus for orienting and conveying small objects. More particularly this invention concerns such an apparatus used to feed pills or the like one at a time to a packaging machine.

### BACKGROUND OF THE INVENTION

In order to package small objects such as pills or capsules, for instance individually in a blister pack, it is necessary to first separate the pills that are typically delivered to the packaging machine in bulk format, that is all jumbled together. The standard machine for doing this has a hopper from which the pills flow into a funnel whose output only lets one object at a time pass into an upstream end of a feed passage. This passage is formed in turn between a normally stationary surface and the periphery of a rotating wheel whose function is to separate the objects from each other.

In U.S. Pat. No. 6,644,460 such an apparatus is described having a funnel holding the objects and having a downwardly open outlet, and a housing and a wheel together forming an arcuate passage generally centered on a horizontal axis and having an upper inlet end at the outlet and a lower outlet end. The objects can enter the upper inlet end of the passage and move downward through the passage. The wheel has an outer periphery forming a radial inner surface of the passage and formed with an annularly continuous row of radially outwardly open pockets of a shape corresponding generally to a shape of the objects. The housing and wheel together form axially directed end surfaces axially bounding the passage, and the housing forms a radially inwardly directed outer surface of the passage radially confronting the periphery of the wheel. The wheel is rotated such that the periphery moves upward in the passage and the objects are separated from one another and aligned behind one another in the passage.

The main problem with this system is that the device is fairly noise. The rotating wheel and such create a fairly irritating and high level of noise that is difficult to reduce while still getting the job done.

### OBJECTS OF THE INVENTION

It is therefore an object of the present invention to provide an improved object sorting and conveying apparatus.

Another object is the provision of such an improved object sorting and conveying apparatus that overcomes the above-given disadvantages, in particular that operates fairly quietly and that is of simple and compact construction, yet which still delivers the objects in the desired orientation one at a time to the downstream packaging machine.

### SUMMARY OF THE INVENTION

This object is achieved according to the invention in a device of the above-described type where the feed passage extends from an opening in the floor of the sorting vessel and two bodies have faces that diverge upward from the opening and form a funnel opening downward at the opening. A drive can shift the bodies relative to the opening.

This device distinguishes itself by the fact that the desired orientation of the bulk material is achieved in an easy manner by the two faces that confront each other so that the bulk material is fed to the feed passage under the force of gravity as the object moves downward along the faces. Clumping of the bulk material is therein avoided by the shifting of the bodies by means of the drive, or a wedge or stirring effect created during shifting of the bodies. The body drive can be realized in a very simple manner without the requirement of a complicated and expensive bearing.

Furthermore, it is provided within the scope of the invention, that the funnel is formed also by two partition or side walls. These walls do not have to contribute to the orientation of the bulk material that moves along the faces, and solely prevents the bulk material from flowing down laterally under the gravitation impact from the faces.

In such a design, there is also the possibility that there be a plurality of such funnels in a row within the sorting vessel, so that in an easy manner a considerable increase of output of the device is achieved.

A particularly preferred embodiment of the invention is characterized in that each body has its own drive for moving it independently of the other body. With this design, a high flexibility in the use of the device is achieved, in which depending on a suitable drive of the body drive, a movement in the same direction of the opposite bodies can be achieved as well as a movement in an opposite direction, wherein it is even possible to reverse the movement pattern in a periodic or stochastic way for a reinforced agitation and stirring of the bulk material.

It is furthermore advantageous if at least one of the body has an adjustable stop or abutment, since this way the amplitude of the movement of the bodies can be modified and can be for example adapted to the size of the objects of the bulk material. This adjustable abutment can be realized in an easy manner by forming the abutment with an adjusting screw which is mounted in the sorting vessel.

Within the scope of the invention, it is further provided that the body drive is designed as a drive which is actuated by fluid pressure, in particular that the body drive is a pneumatic drive. The use of this drive mode is evident in particular with regard to an operation mode which produces as little noise as possible, since only a few pieces are in motion without the noise development caused by motors to generate the required movement the body. This way the pneumatic cylinder of the pneumatic drive can be a membrane or diaphragm cylinder, since this leads to an operation mode with little noise at low wear.

Since the device according to the invention is particularly suitable for the use in the pharmaceutical field or in the processing of food, the diaphragm of the diaphragm cylinder consists of a material which is authorized in pharmaceutical regard and in respect of food legalization, for preventing contamination of the bulk material which might be dangerous in pharmaceutical regard and in respect of food regulations.

Another preferred embodiment of the invention is characterized in that the body drive has a drive control with a oscillator for variably setting a frequency of the cyclic movement of the body. This results in a very high variability with regard to the movement pattern which is imparted to the bodies by the body drive, which can be selected corresponding to the form, size, surface design of the individual objects of the bulk material in an optimized manner. An adaptation to the size of the objects which the bulk material forms also serves for the stroke of the body being adjustable.

### BRIEF DESCRIPTION OF THE DRAWING

The above and other objects, features, and advantages will become more readily apparent from the following description, reference being made to the accompanying drawing in which:

FIG. 1 is a partly diagrammatic vertical section through the device according to the invention taken along section line I-I of FIG. 2;

FIG. 2 is a top view taken the direction of arrow II of FIG. 1.

### SPECIFIC DESCRIPTION

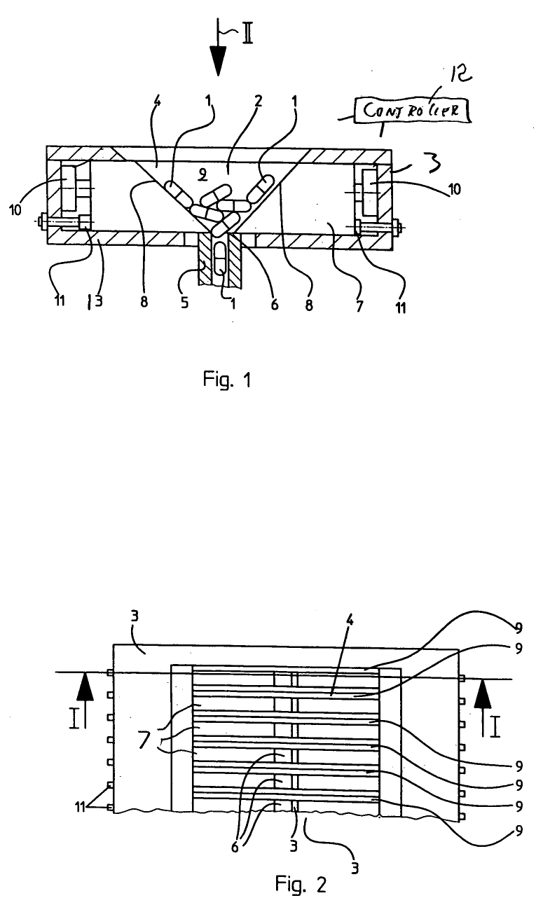

FIGS. 1 and 2 show a device for targeted orientation and onward transfer of bulk material 2 formed by individual objects 1, in particular in small pieces, for example for depositing the individual objects 1 of the bulk material 2 in a targeted manner into packages, e.g. blister packs, not shown in the drawing. The device comprises a funnel 4 in a sorting vessel 3 having a floor 13. There are several such funnels 4 in a row in the sorting vessel 3, each funnel 4 of this arrangement being substantially the same.

Each funnel 4 opens in a downward transport direction into a feed passage 5 that is connected to an aperture 6 in the floor 13 of the sorting vessel 3. On two opposite sides of the hoper 4 are formed funnel walls consisting of two bodies 7 with planar faces 8 which are inclined respectively to the aperture 6, extending at an angle of 90° to each other and symmetrically flanking a vertical plane centered on the respective aperture 6. The funnels 4 are otherwise closed laterally by two parallel and vertical side or partition walls 9 between which the bodies 7 are confined. The bodies 7 each have a respective body drive 10 for shifting of the bodies 7 horizontally relative to the aperture 6, wherein each body has an own body drive 10.

In the example of embodiment shown in the drawing, each of the bodies has an adjustable abutment 11 which is formed in the sorting vessel 3 by an adjusting screw, so that the horizontal reciprocation stroke of each body 7 can be varied and limited in a defined manner. More particularly, each such abutment limits the outward displacement of the respective body 7, the inward displacement normally being limited to a position with the lower innermost edge of the face 8 just at the respective outer edge of the aperture 6.

In the embodiment shown in the drawing the body drive 10 is operated by fluid pressure, here being a pneumatic drive, in which the pneumatic cylinder is designed as a membrane cylinder. The membrane of the membrane cylinder consists of a material that is biocompatible, that is that can be used with food or medicaments. Furthermore, it is to be noted that each drive is controllable with respect to reciprocation frequency of the respective body 7.

In the following, the operation mode of the device which has been described in the foregoing will be shortly described. At the start, the bulk material 2 which is formed by the individual objects 1 is filled into the funnel 4 so that the bulk material 2 lies against the faces 8 of the two bodies 7, which are opposite to each other. Dependent on the size, the dimensions, the shape and/or the surface of the individual objects 1 of the bulk material 2, movement is imparted to the two bodies 7 by means of the body drive 10 in the form of a reciprocatory oscillating movement. The bodies 7 can either move together, that is both shifting as shown in FIG. 1 to the right and then to the left, or they can be shifted oppositely, moving apart and then together. With the second system the size of the funnel 4 which is defined by the faces 8 is constantly changing.

The movement stroke of each body 7 can also be modified via the drive, and in particular for preventing formation of or for breaking up clumps in the bulk material 2, another stroke as well as another frequency can be selected. In this case an asynchronous movement of the two opposite body 7 can be employed.

We claim:

1. An apparatus for orienting and conveying small objects, the apparatus comprising:
a vessel having a horizontal floor having an upper face and formed with a throughgoing aperture;
a conveyor passage extending away from the aperture;
a pair of bodies on the floor flanking the aperture and having confronting and upwardly diverging faces forming a funnel open downward at the aperture;
respective drive means for shifting the bodies toward and away from each other.

2. The orienting and conveying apparatus defined in claim 1 wherein the vessel has two upright side walls flanking the bodies and forming the funnel therewith.

3. The orienting and conveying apparatus defined in claim 2 wherein the vessel floor has at least two such apertures and the vessel has more than two such side walls, more than two pairs of bodies forming respective such funnels with the side walls at the apertures.

4. The orienting and conveying apparatus defined in claim 1 wherein the drive means are operable to shift the bodies independently of each other.

5. The orienting and conveying apparatus defined in claim 1, further comprising:
stop means in the vessel for limiting displacement of at least one of the bodies.

6. The orienting and conveying apparatus defined in claim 5 wherein the stop means includes an abutment screw threaded in the vessel, engageable with the one body, and extending parallel to a displacement direction of the one body.

7. The orienting and conveying apparatus defined in claim 1 wherein the drive means is fluid-powered.

8. The orienting and conveying apparatus defined in claim 7 wherein the drive means is pneumatic.

9. The orienting and conveying apparatus defined in claim 8 wherein the drive means has an actuating membrane.

10. The orienting and conveying apparatus defined in claim 9 wherein the membrane is of a biologically compatible material.

11. The orienting and conveying apparatus defined in claim 1 wherein the drive means reciprocate the bodies.

12. The orienting and conveying apparatus defined in claim 11, further comprising stop means for limiting displacement of the bodies.

13. The orienting and conveying apparatus defined in claim 1 wherein the drive means reciprocates the bodies opposite to each other with the bodies moving simultaneously together and then apart.
